(19) United States
(12) Patent Application Publication
(10) Pub. No.: US 2004/0254663 A1
(43) Pub. Date: Dec. 16, 2004

(54) Device for providing audio output and related systems and methods

(76) Inventor: Stephen G. Dame, Everett, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/868,295

(22) Filed: Jun. 14, 2004

Related U.S. Application Data
(60) Provisional application No. 60/478,232, filed on Jun. 12, 2003.

(51) Int. Cl. G06F 17/00

(52) U.S. Cl. 700/94

(57) ABSTRACT

An apparatus comprises an input element operable to receive data from an electronic system. A first interface is coupled to the input element and is coupleable to a first speaker. A first amplifier circuit is coupled to the first interface and receives power from a supply external to the apparatus.

### BACKGROUND

In the past, Universal Serial Bus (USB) Audio peripheral devices have been developed and produced that convert the digital audio stream present on USB Audio Spec compliant computers to line level outputs or equivalent levels for stereo headphones.

In the past, these USB audio peripheral devices have been popular in providing both input and output ports for audio as a means to simplify digital audio connections to computers as well as provide for better separation from the higher electrical noise present inside the faraday enclosures of typical computer systems. These systems typically produce only one pair of audio inputs and outputs and do not usually have even a single stereo headphone output adequate for driving typical stereo audio headphone speakers in the 32-ohm impedance range and with higher quality sound with less than 1% total harmonic distortion.

### SUMMARY

According to an embodiment of the present invention, an apparatus comprises an input element operable to receive data from an electronic system. A first interface is coupled to the input element and is coupleable to a first speaker. A first amplifier circuit is coupled to the first interface and receives power from a supply external to the apparatus.

### BRIEF DESCRIPTION OF THE DRAWINGS

FIG. 1 is an elevated isometric view of a USB “dongle” according to an embodiment of the invention;

FIG. 2 is an internal block diagram of a four-headphone driver system according to an embodiment of the invention; and

FIG. 3 is a schematic illustration of the gain circuit block of FIG. 2 according to an embodiment of the invention.

### DETAILED DESCRIPTION

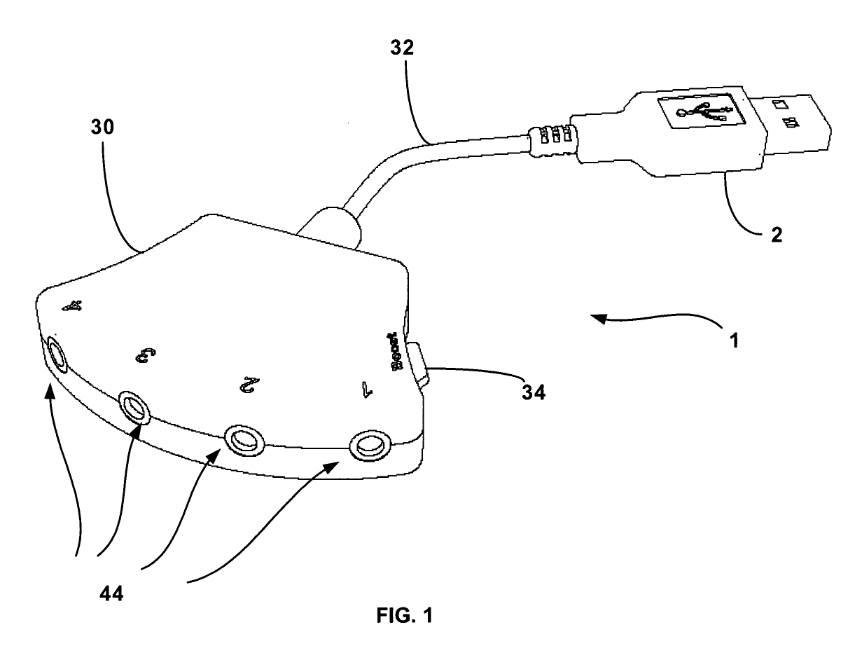

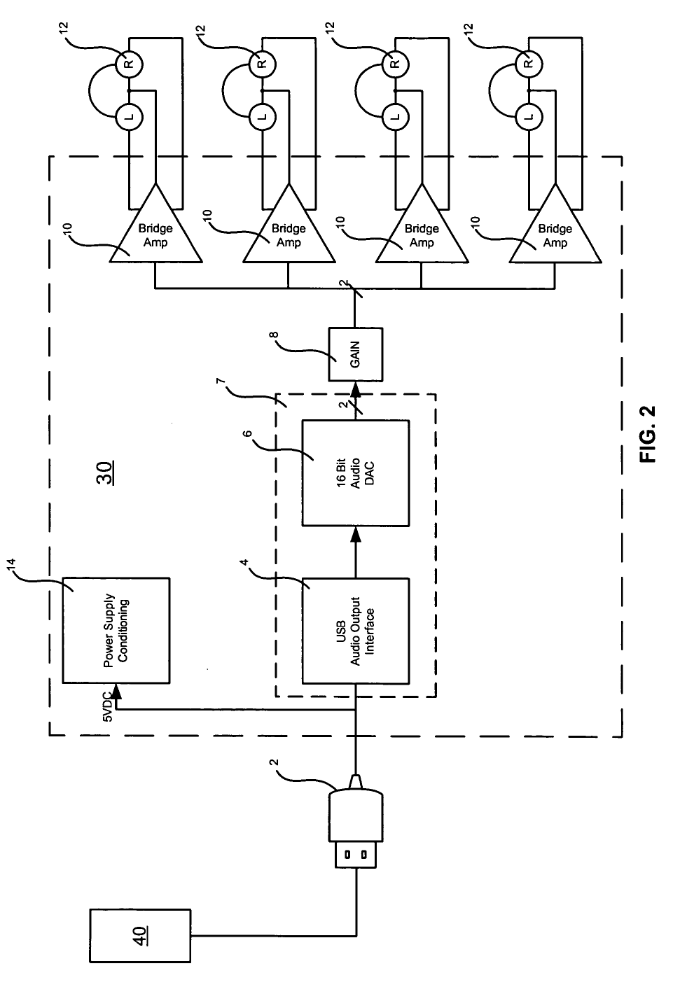

FIGS. 1 and 2 illustrate a device 1, according to an embodiment of the invention, for providing audio output. The device 1 may include a housing 30 coupled by a shielded cable 32 to a shielded USB Type A connector 2. The housing 30 may comprise, for example, molded plastic and provide electromagnetic shielding required by certification standards such as the European “CE” and US FCC regulatory agencies. The connector 2 may be connected to a USB-compatible computer 40 and may thus provide power and grounding to the elements (described in detail below) within the housing 30. The connector 2 may further provide digital data signals to/from the computer 40 to/from the housing 30.

As best illustrated in FIG. 2, disposed within the housing 30 is a power supply conditioning circuit 14 that provides power-supply filtering and voltage step down to, for example, 3.3 VDC from the input 5 VDC so that the entire device 1 is “bus powered” by the computer 40 via the USB connector 2.

A USB interface 4 is programmed to respond to the isochronous audio output protocol specified in, for example, the USB Audio Specification (version 1.0). Connected to the interface 4 is a stereo 16-bit digital to analog converter (DAC) 6 that provides stereo audio line level outputs from the digital audio stream decoded from the USB data stream.

A stereo gain amplifier 8 provides additional volume control and user-controlled volume boosting as an option prior to headphone amplification. The gain amplifier 8 may be activated/deactivated by a button 34 or other appropriate control. Two or more parallel headphone driver amplifiers 10 may provide bridged, non-coupling capacitor drive power to typical 32 ohm stereo headsets 12.

In a preferred embodiment, an integrated USB interface and 16-bit DAC chip 7 may be selected from, for example, Burr Brown (PCM2702E), which provides the best space and power savings over any other available discrete combination of a USB Interface 4 and audio DAC 6. However, it should be clearly understood that an equivalent system can be fabricated out of separate USB and DAC integrated circuits.

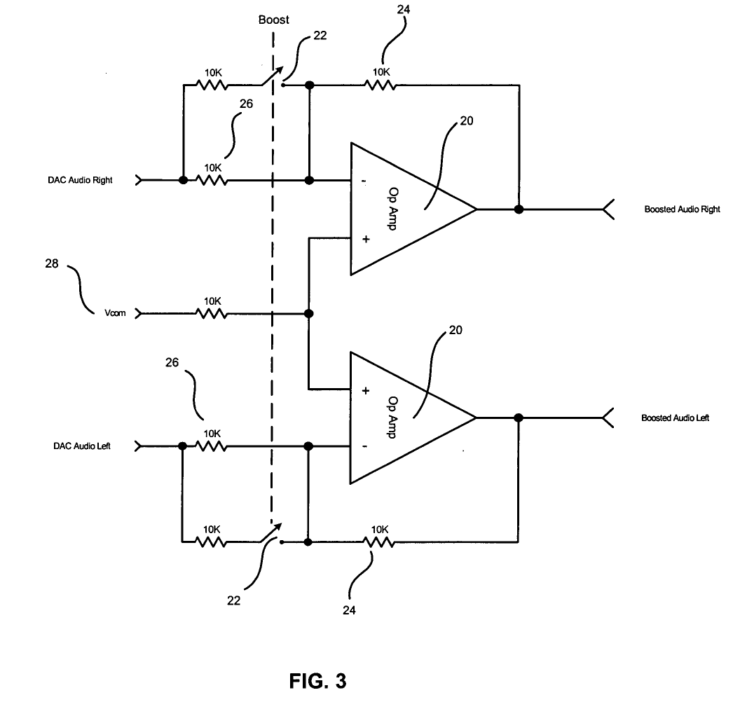

Referring to FIG. 3, the stereo outputs of the DAC 6 are passed through a gain stage 8 employing operational amplifiers 20. The gain stage 8 has the capability of adding, for example, 6 dB of increased volume (boost) to the stereo signal pair under user control by switching with switches 22 additional resistor pairs 24 in parallel with the main input gain resistors 26. Under normal ambient noise conditions, the boost will not likely be required, but for higher noise environments, such as an aircraft passenger compartment, the volume boost provides an increase in volume that can enhance the listening quality. The common voltage level Vcom 28 is a DC reference voltage that biases the positive input of the operational amplifiers 20 to a midscale voltage so that the amplifiers are working at the same DC voltage level as the output of the DAC.

The stereo output of the gain stage 8 is then connected in parallel to each of the individual headphone amplifiers 10. Each of the headphone amplifiers 10 provides, for example, 35 mW of output power into, for example, 32-ohm impedance headsets 12. Some circuits of the device 1 operate from 5 VDC and only require some capacitive decoupling from the USB 5 VDC input power. Other circuits operate at 3.3 VDC and require an additional step down regulation and capacitive filtering provided by the power supply conditioning circuits 14. The USB DAC 7 subsystem operates at 3.3 V while the output headphone amplifiers operate at a supply voltage of 5 VDC to give them more of a range for the AC audio signal to swing above and below 2.5 V.

A specially designed plastic molded housing 30 ensures proper shielding, strain relief of the USB cable 32, and provides an arced spacing of headphone jacks 44 for easy plug and unplug of, for example, headphone 3.5 mm plugs (not shown).

The device 1, according to an embodiment of the invention, operates by first plugging the USB connector 2 into the computer 40 and causing a device discovery to occur within the computer 40 operating system. All contemporary operating system versions from, for example, Microsoft and Apple are capable of automatically recognizing devices that are compatible with the USB version 1.0 audio specification. No additional drivers are required since this device is a plug and play system.

Once the operating system has configured for this device, it shows up as an alternative audio output device on the system list of valid plugged in devices. Various audio sources within the computer such as, for example, Windows Media Player™, Apple QuickTime Player™, Music Match Jukebox™, or any other system sound can be redirected to this output USB port.

In a preferred embodiment, up to four users can simultaneously listen to the high quality audio content by plugging in headsets 12. The advantages of such a capability are clearly understood in environments such as multiple children riding in a car and watching a digital video disk (DVD) program on a portable computer, business associates traveling together on a commercial airliner and working on multimedia presentations, or teaching environments where two or more individuals need to view multimedia content in private groups where the groups are moving through the content at a different pace.

In an embodiment, the user may adjust the output volume over the entire range of hearing by using the software control panels within the computer system 40. As an option, the user may also elect to switch 34 on the boost capability within the device 1 to overcome very loud ambient environments.

In an alternative embodiment, instead of having 4 outputs, less expensive products can be built with fewer components to provide a more optimized number of channels such as 2, 3 or even a greater number of output channels such as 8.

In another alternative embodiment, an increased number of bits in the DAC (such as using a 24-bit device) can be employed to achieve professional audio quality.

In another alternative embodiment, a fixed increased gain can be implemented rather than the boost if a best increased gain setting is determined to be preferable to boost switching capability as a simplification for certain markets.

In another alternative embodiment, a continuously variable analog gain can be implemented rather than the fixed or switchable boost gain which allows the user to adjust the volume of all headphones simultaneously or individually depending on user preference without having to utilize the user interface of the personal computer system.

In another alternative embodiment, a continuously variable digital gain can be implemented by including controls such as up down volume pushbuttons and/or a rotary encoder wheel such that the software volume of the personal computer system is adjusted by this remote external control on the USB device.

In another alternative embodiment, a battery operated version of the device 1 can be used to provide a single stereo analog input to multiple analog output versions of the device 1 as an option. This battery operated device 1 could also employ a rechargeable battery that derives its recharge from the excess unused power on the USB connection up to 500 mA.

In another alternative embodiment, a smaller device 1 that is all built into the USB connector 2 could be a form factor option particularly if fewer channels were used, such as two stereo outputs instead of four.

In another alternative embodiment, a longer-cable 32 version of the product could be an option for extending the headphone jacks 44 further from the computer host unit 40.

An embodiment of the invention provides a method for producing multiple high quality stereo audio headphone outputs from a single USB connection. A standard USB Type A plug 2 may provide power and digital communication signals to a USB interface controller device 4 which is programmed to receive digital audio in accordance with the USB Audio Interface Specification. The USB interface controller 4 is connected to a 16-bit (or greater) digital to analog (DAC) converter 6 which produces stereo analog line level outputs. These line level outputs are first amplified by either a fixed or user controllable amount of gain to increase the volume. This amplified gain is then applied to multiple stereo headphone amplifier circuits 10 that drive standard audio headphones 12 in a bridge voltage swing configuration to maximize the amount of audio power delivered to each headphone speaker.

A method, according to an embodiment of the invention, of producing audio stereo headphone output is preferable over previous USB peripheral audio devices because it provides two or more specially amplified headphone outputs, extra volume to the headphone amplifiers, as well as a bridged headphone amplification scheme which allows for more efficient use of the USB bus power and a smaller package size due to the elimination of typically large output capacitors required in non-bridged amplifier circuits.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. For example, the invention is not limited to headphone speaker applications; rather, embodiments of the present invention may be practiced in conjunction with any type of audio speaker. In addition, the device 1 may itself include such headphones or other speakers. Thus, the present invention is not intended to be limited to the embodiments shown, but is to be accorded the widest scope consistent with the principles and features disclosed herein.

What is claimed is:

1. An apparatus, comprising:
an input element operable to receive data from an electronic system;
a first interface coupled to the input element, the first interface coupleable to a first speaker; and
a first amplifier circuit coupled to the first interface, the first amplifier circuit receiving power from a supply external to the apparatus.

2. The apparatus of claim 1 wherein the input element comprises a Universal Serial Bus connector.

3. The apparatus of claim 1, further comprising a second interface coupled to the input element, the second interface coupleable to a second speaker.

4. The apparatus of claim 1 wherein the first speaker comprises an audio headphone set.

5. The apparatus of claim 1 wherein the first amplifier circuit comprises a bridged amplifier circuit.

6. The apparatus of claim 1, further comprising a second amplifier circuit coupled to the input element.

7. The apparatus of claim 6 wherein the second amplifier circuit is operable to provide user-controllable gain levels.

8. The apparatus of claim 1 wherein the first amplifier circuit receives power solely from a supply external to the apparatus.
